(19) United States
(12) Patent Application Publication
(10) Pub. No.: US 2011/0150247 A1
(43) Pub. Date: Jun. 23, 2011

(54) System and method for applying a plurality of input signals to a loudspeaker array

(76) Inventor: Rene Martin Oliveras, Florham Park, NJ (US)

(21) Appl. No.: 12/653,668

(22) Filed: Dec. 17, 2009

(51) Int. Cl. H04R 5/02; G01P 15/00

(52) U.S. Cl. 381/304; 73/514.16; 381/300

(57) ABSTRACT

According to one embodiment of the present invention, an electronic device comprises: A housing, the housing further comprising a first surface; A sound producing transducer array further comprising a plurality of sound producing transducers; the sound producing transducer array being located on the first surface of the housing; a first set of input audio signals being applied to the sound producing transducers when the electronic device is in a first spatial orientation; and a second set of input audio signals being applied to the sound producing transducers when the electronic device is in a second spatial orientation.

### BACKGROUND OF THE INVENTION

1. Field of the Invention

This invention relates to a System And Method For Applying A Plurality Of Input Signals To A Loudspeaker Array and in particular to such a system and method associated with an electronic device such as an iPhone.

2. Description of the Prior Art

The prior art reveals several references as follows:
1) Abe et al patent application publication number 2006-0046848, published on Mar. 2, 2006, and entitled “GAME APPARATUS, STORAGE MEDIUM STORING A GAME PROGRAM, AND GAME CONTROL METHOD”, reveals:

A game apparatus includes a housing of a size capable of being held by a player, a display screen provided in the housing, and a gyro sensor for detecting an angular velocity of a rotation around an axis perpendicular to the display screen. When the player rotates the game apparatus itself around the axis perpendicular to the display screen, a rotation angle of the housing is calculated on the basis of the detected angular velocity. The display screen displays a game image including a rotational image rotated according to the rotation angle and an irrotational image controlled independently of the rotation angle. The rotational image is controlled so as to rotate in a direction opposite to the rotation angle and by the same degree of angle as the rotation angle, for example. It thus appears to the player that the rotational image stands still and the irrotational image makes a rotational movement. It is determined whether or not some predetermined requirements are satisfied in a relationship between the rotational image and the irrotational image, and the progress of the game is changed according to a result of the determination.

A motion-sensing and attitude-sensing system integrated into an electronic device having an application program that is executable on the electronic device, the system comprising: a three-axis ACCELEROMETER that is adapted to provide a first set of signals associated with a change in attitude of the electronic device; and a three-axis magnetic field sensor that is adapted to provide a second set of signals associated with a change in attitude of the electronic device, wherein the three-axis magnetic field sensor is a magnetic compass.

An electronic device including an application program that is executable thereon, the electronic device comprising: a motion- and attitude-sensing system including: a three-axis ACCELEROMETER that is adapted to provide a first set of signals associated with a change in attitude of the electronic device; and a three-axis magnetic field sensor that is adapted to provide a second set of signals associated with a change in attitude of the electronic device.

A system for generating input signals to an application program that is being executed by an apparatus, the system comprising: memory for storing the application program, an input signal calculation program, and a calibration program; an ACCELEROMETER that is integrated into the apparatus and adapted to generate continuous signals related to a pitch angle and a roll angle of the apparatus; a magnetic field sensor that is integrated into the apparatus and adapted to generate continuous signals related to a yaw angle of the apparatus; and processor operatively coupled to the memory, the ACCELEROMETER, and the magnetic field sensor, the processor being adapted to execute the application program, execute the input signal calculation program, and execute the calibration program using the signals from the ACCELEROMETER and the magnetic filed sensor, wherein the magnetic sensor is a magnetic compass.

A method for providing input signals corresponding to inertial attitude and/or a change in inertial attitude to an application program for execution on a device, the method comprising: integrating a two-axis or three-axis ACCELEROMETER and a three-axis magnetic field sensor into the device that executes the application program; sensing at least one of acceleration and magnetic field strength of the device using the two-axis or three-axis ACCELEROMETER and the three-axis magnetic field sensor; generating said input signals that are proportional to said acceleration and said magnetic field strength; and providing said input signals to the application program to change an operation performed by the application program, wherein the three-axis magnetic field sensor integrated into the device is a magnetic compass.

A method for determining the inertial attitude and/or change in inertial attitude of an object in space and for changing an operation performed by an application program executed on the object in space, the method comprising: integrating a two-axis or three-axis ACCELEROMETER and a three-axis magnetic field sensor into the object; detecting an inertial attitude and/or an angular velocity of the object using the two-axis or three-axis ACCELEROMETER and the three-axis magnetic sensor; generating an input signal proportional to said inertial attitude and/or said angular velocity; and inputting the input signal into the application program, wherein the three-axis magnetic field sensor integrated into the device is a magnetic compass.

A method for providing input signals corresponding to inertial attitude and/or a change in inertial attitude to an application program for execution on a device, the method comprising: integrating a two-axis or three-axis ACCELEROMETER and a three-axis magnetic filed sensor into the device; sensing an inertial attitude of the device; generating an angular velocity signal when the device rotates; generating an input signal that is proportional to the angular velocity signal; and providing the input signal to the application program to change an operation performed by said application program, wherein the three-axis magnetic field sensor integrated into the device is a magnetic compass.

A method of generating input signals to an application program that is executable on an electronic device, the method comprising: integrating a two-axis or three-axis ACCELEROMETER and a three-axis magnetic field sensor into the electronic device; adapting the two-axis or three-axis ACCELEROMETER to produce a first set of signals that is proportional to a change in attitude of the electronic device; adapting the three-axis magnetic field sensor to produce a second set of signals that is proportional to a change in attitude of the electronic device; processing the first and second set of signals; calculating pitch, roll, and yaw, and angular rotation about an X-axis, a Y-axis, and a Z-axis using the first and second sets of signals; and translating the pitch, roll, and yaw, and angular rotation about the X-axis, the Y-axis, and the Z-axis into an input signal for the application program, wherein the three-axis magnetic field sensor integrated into the device is a magnetic compass.
2) Robin et al U.S. Pat. No. 7,138,979, issued on Nov. 21, 2006, and entitled “DEVICE ORIENTATION BASED INPUT SIGNAL GENERATION”, reveals:

A method (500) and apparatus (601) generate an input signal based on the orientation of a device. A sensor (302) such as a camera, a gyro, or an ACCELEROMETER detects a change in device orientation and generates a position input signal that is provided to an application program (612) such as a game program, a text messaging program, or a user interface program to affect an operation thereof. The input signal can, for example, affects a navigation position associated with the application program.

A method for providing an input to an application program executing on a device, the method comprising: detecting a change in an orientation of the device; generating an input signal associated with the change in the orientation; providing the input signal to the application program to change an operation performed by the application program, the application program comprising a simulated keyboard program and the providing the input signal facilitating use of the simulated keyboard program, wherein: the input signal includes position information, the providing includes avoiding position information to change a cursor position associated with the simulated keyboard program, the cursor position is associated with a key on the simulated keyboard program; and selecting the key when the cursor position coincides with the key.

A method for controlling a cursor position associated with an application program executing on a device, the method comprising: detecting a change in an orientation of the device relative to a reference position of the device; using a sensor comprising one or more of a camera and a gyro to generate a position signal associated with the change in the orientation; processing the position signal based on a sensor type associated with the sensor to generate a cursor position signal; and updating the cursor position based on the cursor position signal, wherein the application program includes a user interface program, and wherein the updating the cursor position further comprises updating the cursor position associated with the user interface program, the cursor position corresponding to a selection position associated with a single action of the user interface program, and wherein the action associated with the selection position is selected when the cursor position coincides with the selection position and a select signal is generated.

An apparatus for navigating within an application program in a device, the apparatus comprising: a memory for storing the application program, the application program further including a program for facilitating text entry and text processing; a sensor having an associated sensor type, the sensor adapted to: determine an orientation of the device, and generate a position signal proportional to a change in the orientation of the device; a processor coupled to the memory and the sensor, the processor adapted to: execute the application program, process the position signal according to the sensor type to generate a navigation position, and update a navigation action associated with the application program using the navigation position; and a selector coupled to the processor, the selector configured to generate a select signal, wherein the application program includes a user interface program, wherein the processor in updating the navigation action is further configured to update the navigation action associated with the user interface program, the navigation position corresponding to a selection position associated with a single action of the user interface program, and wherein the action associated with the selection position is selected when the position coincides with the selection position and the select signal is generated.
3) Zhao et al patent application publication number 2008-0042973, published on Feb. 21, 2008, and entitled “SYSTEM FOR SENSING YAW RATE USING A MAGNETIC FIELD SENSOR AND PORTABLE ELECTRONIC DEVICES USING THE SAME”, reveals:

An attitude- and motion-sensing system for an electronic device, such as a cellular telephone, a game device, and the like, is disclosed. The system, which can be integrated into the portable electronic device, includes a two-axis or three-axis ACCELEROMETER and a three-axis magnetic compass. Data about the attitude of the electronic device from the ACCELEROMETER and magnetic compass are first processed by a signal processing unit that calculates attitude angles (pitch, roll, and yaw) and rotational angular velocities. These data are then translated into input signals for a specific application program associated with the electronic device.

A motion-sensing and attitude-sensing system integrated into an electronic device having an application program that is executable on the electronic device, the system comprising: a three-axis ACCELEROMETER that is adapted to provide a first set of signals associated with a change in attitude of the electronic device; and a three-axis magnetic field sensor that is adapted to provide a second set of signals associated with a change in attitude of the electronic device, wherein the three-axis magnetic field sensor is a magnetic compass.

An electronic device including an application program that is executable thereon, the electronic device comprising: a motion- and attitude-sensing system including: a three-axis ACCELEROMETER that is adapted to provide a first set of signals associated with a change in attitude of the electronic device; and a three-axis magnetic field sensor that is adapted to provide a second set of signals associated with a change in attitude of the electronic device.

A system for generating input signals to an application program that is being executed by an apparatus, the system comprising: memory for storing the application program, an input signal calculation program, and a calibration program; an ACCELEROMETER that is integrated into the apparatus and adapted to generate continuous signals related to a pitch angle and a roll angle of the apparatus; a magnetic field sensor that is integrated into the apparatus and adapted to generate continuous signals related to a yaw angle of the apparatus; and processor operatively coupled to the memory, the ACCELEROMETER, and the magnetic field sensor, the processor being adapted to execute the application program, execute the input signal calculation program, and execute the calibration program using the signals from the ACCELEROMETER and the magnetic filed sensor, wherein the magnetic sensor is a magnetic compass.

A method for providing input signals corresponding to inertial attitude and/or a change in inertial attitude to an application program for execution on a device, the method comprising: integrating a two-axis or three-axis ACCELEROMETER and a three-axis magnetic field sensor into the device that executes the application program; sensing at least one of acceleration and magnetic field strength of the device using the two-axis or three-axis ACCELEROMETER and the three-axis magnetic field sensor; generating said input signals that are proportional to said acceleration and said magnetic field strength; and providing said input signals to the application program to change an operation performed by the application program, wherein the three-axis magnetic field sensor integrated into the device is a magnetic compass.

A method for determining the inertial attitude and/or change in inertial attitude of an object in space and for changing an operation performed by an application program executed on the object in space, the method comprising: integrating a two-axis or three-axis ACCELEROMETER and a three-axis magnetic field sensor into the object; detecting an inertial attitude and/or an angular velocity of the object using the two-axis or three-axis ACCELEROMETER and the three-axis magnetic sensor; generating an input signal proportional to said inertial attitude and/or said angular velocity; and inputting the input signal into the application program, wherein the three-axis magnetic field sensor integrated into the device is a magnetic compass.

A method for providing input signals corresponding to inertial attitude and/or a change in inertial attitude to an application program for execution on a device, the method comprising: integrating a two-axis or three-axis ACCELEROMETER and a three-axis magnetic field sensor into the device; sensing an inertial attitude of the device; generating an angular velocity signal when the device rotates; generating an input signal that is proportional to the angular velocity signal; and providing the input signal to the application program to change an operation performed by said application program, wherein the three-axis magnetic field sensor integrated into the device is a magnetic compass.

A method of generating input signals to an application program that is executable on an electronic device, the method comprising: integrating a two-axis or three-axis ACCELEROMETER and a three-axis magnetic field sensor into the electronic device; adapting the two-axis or three-axis ACCELEROMETER to produce a first set of signals that is proportional to a change in attitude of the electronic device; adapting the three-axis magnetic field sensor to produce a second set of signals that is proportional to a change in attitude of the electronic device; processing the first and second set of signals; calculating pitch, roll, and yaw, and angular rotation about an X-axis, a Y-axis, and a Z-axis using the first and second sets of signals; and translating the pitch, roll, and yaw, and angular rotation about the X-axis, the Y-axis, and the Z-axis into an input signal for the application program, wherein the three-axis magnetic field sensor integrated into the device is a magnetic compass.
4) iPHONE

The touchscreen of the iPhone is a liquid crystal display (320×480 px at 6.3 px/mm, 160 ppi, HVGA) with scratch-resistant glass, and uses 18-bit colour (can render 262,144 colors). The capacitive touchscreen is designed for a bare finger, or multiple fingers for multi-touch sensing. The iPhone 3GS features a new Fingerprint-resistant oleophobic coating.

The touchscreen display responds to three sensors. (1) A proximity sensor for deactivating the display and touchscreen when the device is brought near the face during a call. This is done to save battery power and to prevent in-advertent inputs from the user's face and ears. (2) An ambient light sensor for adjusting the display brightness which in turn saves battery power. (3) A 3-axis ACCELEROMETER for sensing the orientation of the iPhone and for changing the screen thereby allowing the user to switch between the PORTRAIT and LANDSCAPE modes. Photo browsing, web browsing, and music playing support both up-right portrait and left or right widescreen LANDSCAPE orientations. The 3.0 update added LANDSCAPE support for still other applications, such as email, and introduced shaking the unit as a form of input. The ACCELEROMETER can also be used to control third party applications, notably games.

The built-in ACCELEROMETER makes the iPhone respond to change the display from PORTRAIT to LANDSCAPE (or vice versa) when the user rotates the device from vertical to horizontal (or vice versa). As you change the way you are holding the phone, the iPhone switches the display.

The iPhone responds to motion using a built-in ACCELEROMETER. When the iPhone is rotated from PORTRAIT to LANDSCAPE, the ACCELEROMETER detects the movement and changes the display accordingly. The ACCELEROMETER also gives good game control.

One of two loudspeakers and the microphone surround the dock connector on the base of the iPhone. If a headset is plugged in, sound is played through the headset instead. One loudspeaker is located above the screen as an earpiece, and another is located on the left side of the bottom of the unit, opposite the microphone on the bottom-right. Loudspeaker Volume controls are located on the left side of the unit and as a slider in the iPod application. Both loudspeakers are used for handsfree operations and media playback. The 3.5 mm TRRS connector for the headphones is located on the top left corner of the device.

The layout of the music library is similar to that of an iPod or current Symbian S60 phones. The iPhone can sort its media library by songs, artists, albums, videos, playlists, genres, composers, podcasts, audiobooks, and compilations. Options are always presented alphabetically, except in playlists, which retain their order from iTunes. The iPhone uses a large font that allows users plenty of room to touch their selection. Users can rotate their device horizontally to LANDSCAPE mode to access Cover Flow. Like on iTunes, this feature shows the different album covers in a scroll-through photo library. Scrolling is achieved by swiping a finger across the screen. Alternatively, headset controls can be used to pause, play, skip, and repeat tracks. On the iPhone 3GS, the volume can be changed with the included Apple Earphones, and the Voice Control feature can be used to identify a track, play songs in a playlist or by a specific artist, or create a Genius playlist.

The iPhone supports gapless playback. Like the fifth generation iPods introduced in 2005, the iPhone can play digital video, allowing users to watch TV shows and movies in widescreen. Unlike other image-related content, video on the iPhone plays only in the LANDSCAPE orientation, when the phone is turned sideways. Double-tapping the screen switches between widescreen and fullscreen video playback.

Safari is the iPhone's native web browser, and it displays pages similar to its Mac and Windows counterpart. Web pages may be viewed in PORTRAIT or LANDSCAPE mode and supports automatic zooming by pinching together or spreading apart fingertips on the screen, or by double-tapping text or images. The iPhone supports SVG, CSS, HTML Canvas, and Bonjour.

For text input, the iPhone implements a virtual keyboard on the touchscreen. It has automatic spell checking and correction, predictive word capabilities, and a dynamic dictionary that learns new words. The keyboard can predict what word the user is typing and complete it, and correct for the accidental pressing of keys adjacent to the presumed desired key. The keys are somewhat larger and spaced farther apart when in LANDSCAPE mode, which is supported by only a limited number of applications.

Touching a section of text for a brief time brings up a magnifying glass, allowing users to place the cursor in the middle of existing text. The virtual keyboard can accommodate 21 languages, including character recognition for Chinese. The 3.0 update brought support for cut, copy, or pasting text, as well as LANDSCAPE keyboards in more applications.

From a review of the above-cited references and from a reading of the following specification, it will be apparent that applicant's claimed invention expands upon and adds to the features disclosed in such cited references.

3. Summary of the Invention

According to one embodiment of the present invention, an electronic device comprises: A housing, the housing further comprising a first surface; A sound producing transducer array further comprising a plurality of sound producing transducers; the sound producing transducer array being located on the first surface of the housing; a first set of input audio signals being applied to the sound producing transducers when the electronic device is in a first spatial orientation; and a second set of input audio signals being applied to the sound producing transducers when the electronic device is in a second spatial orientation.

Objects of the present invention are therefor to:

Allow the application of sets of input audio signals to the loudspeaker array of an electronic device based upon the spatial orientation of the electronic device.
Allow the production of sound effects with the loudspeaker array of an electronic device based upon the spatial orientation of the electronic device.
Allow the application of sets of input audio signals to the loudspeaker array of an electronic device based upon the spatial orientation of the electronic device in conjunction with input audio-video signals.
Allow the production of sound effects with the loudspeaker array of an electronic device based upon the spatial orientation of the electronic device in conjunction with input audio-video signals.

Advantages of the present invention are therefor that:

It can produce sound effects in conjunction with input audio-video signals.

### BRIEF DESCRIPTION OF THE DRAWINGS

The above and other objects, advantages and features of the present invention will be further appreciated from a reading of the following detailed description in conjunction with the drawing in which:

FIGS. 1A through 1I show various views of Electronic Device 100 according to the present invention. FIG. 1A shows a front view of Electronic Device 100 in the 1^{ST} portrait configuration. FIG. 1B shows a left side view of Electronic Device 100. FIG. 1C shows a right side view of Electronic Device 100. FIG. 1D shows a rear view of Electronic Device 100. FIG. 1E shows a top view of Electronic Device 100. FIG. 1F shows a bottom view of Electronic Device 100. FIG. 1G shows a front view of Electronic Device 100 in the 1^{ST} landscape configuration.

FIG. 1H shows a front view of Electronic Device 100 in the 2^{ND} landscape configuration. FIG. 1I shows a front view of Electronic Device 100 in the 2^{ND} portrait configuration.

FIGS. 1J through 1M show the components which route the input audio signals in the various configurations of Electronic Device 100 according to the present invention. FIG. 1J shows the routing of input audio signals in the 1^{ST} portrait configuration. FIG. 1K shows the routing of input audio signals in the 1^{ST} landscape configuration. FIG. 1L shows the routing of input audio signals in the 2^{ND} landscape configuration. FIG. 1M shows routing of input audio signals in the 2^{ND} portrait configuration.

FIGS. 1N and 1P show the axes associated with Electronic Device 100.

FIGS. 2A through 2I show various views of Electronic Device 200 according to the present invention. FIG. 2A shows a front view of Electronic Device 200 in the 1^{ST} portrait configuration. FIG. 2B shows a left side view of Electronic Device 200. FIG. 2C shows a right side view of Electronic Device 200. FIG. 2D shows a rear view of Electronic Device 200. FIG. 2E shows a top view of Electronic Device 200. FIG. 2F shows a bottom view of Electronic Device 200. FIG. 2G shows a front view of Electronic Device 200 in the 1^{ST} landscape configuration. FIG. 2H shows a front view of Electronic Device 200 in the 2^{ND} landscape configuration. FIG. 2I shows a front view of Electronic Device 200 in the 2^{ND} portrait configuration.

FIGS. 2J through 2M show the components which route the input audio signals in the various configurations of Electronic Device 200 according to the present invention. FIG. 2J shows the routing of input audio signals in the 1^{ST} portrait configuration. FIG. 2K shows the routing of input audio signals in the 1^{ST} landscape configuration. FIG. 2L shows the routing of input audio signals in the 2^{ND} landscape configuration. FIG. 2M shows routing of input audio signals in the 2^{ND} portrait configuration.

FIGS. 3A through 3I show various views of Electronic Device 300 according to the present invention. FIG. 3A shows a front view of Electronic Device 300 in the 1^{ST} portrait configuration. FIG. 3B shows a left side view of Electronic Device 300. FIG. 3C shows a right side view of Electronic Device 300. FIG. 3D shows a rear view of Electronic Device 300. FIG. 3E shows a top view of Electronic Device 300. FIG. 3F shows a bottom view of Electronic Device 300. FIG. 3G shows a front view of Electronic Device 300 in the 1^{ST} landscape configuration. FIG. 3H shows a front view of Electronic Device 300 in the 2^{ND} landscape configuration. FIG. 3I shows a front view of Electronic Device 300 in the 2^{ND} portrait configuration.

FIGS. 3J through 3M show the routing of the input audio signals in the various configurations of Electronic Device 300 according to the present invention. FIG. 3J shows the routing of input audio signals in the 1^{ST} portrait configuration. FIG. 3K shows the routing of input audio signals in the 1^{ST} landscape configuration. FIG. 3L shows the routing of input audio signals in the 2^{ND} landscape configuration. FIG. 3M shows the routing of input audio signals in the 2^{ND} portrait configuration.

FIGS. 4A through 4I show various views of Electronic Device 400 according to the present invention. FIG. 4A shows a front view of Electronic Device 400 in the 1^{ST} portrait configuration. FIG. 4B shows a left side view of Electronic Device 400. FIG. 4C shows a right side view of Electronic Device 400. FIG. 4D shows a rear view of Electronic Device 400. FIG. 4E shows a top view of Electronic Device 400. FIG. 4F shows a bottom view of Electronic Device 400. FIG. 4G shows a front view of Electronic Device 400 in the 1^{ST} landscape configuration. FIG. 4H shows a front view of Electronic Device 400 in the 2^{ND} landscape configuration. FIG. 4I shows a front view of Electronic Device 400 in the 2^{ND} portrait configuration.

FIGS. 4J through 4M show the routing of the input audio signals in the various configurations of Electronic Device 400 according to the present invention. FIG. 4J shows the routing of input audio signals in the 1^{ST} portrait configuration. FIG. 4K shows the routing of input audio signals in the 1^{ST} landscape configuration. FIG. 4L shows the routing of input audio signals in the 2^{ND} landscape configuration. FIG. 4M shows the routing of input audio signals in the 2^{ND} portrait configuration.

FIG. 5 shows the components which route the input audio signals in the various configurations of Electronic Device 500 according to the present invention.

FIG. 6 shows the components which route input video signals and input audio signals in the various configurations of Electronic Device 600 according to the present invention.

### DETAILED DESCRIPTION OF THE INVENTION

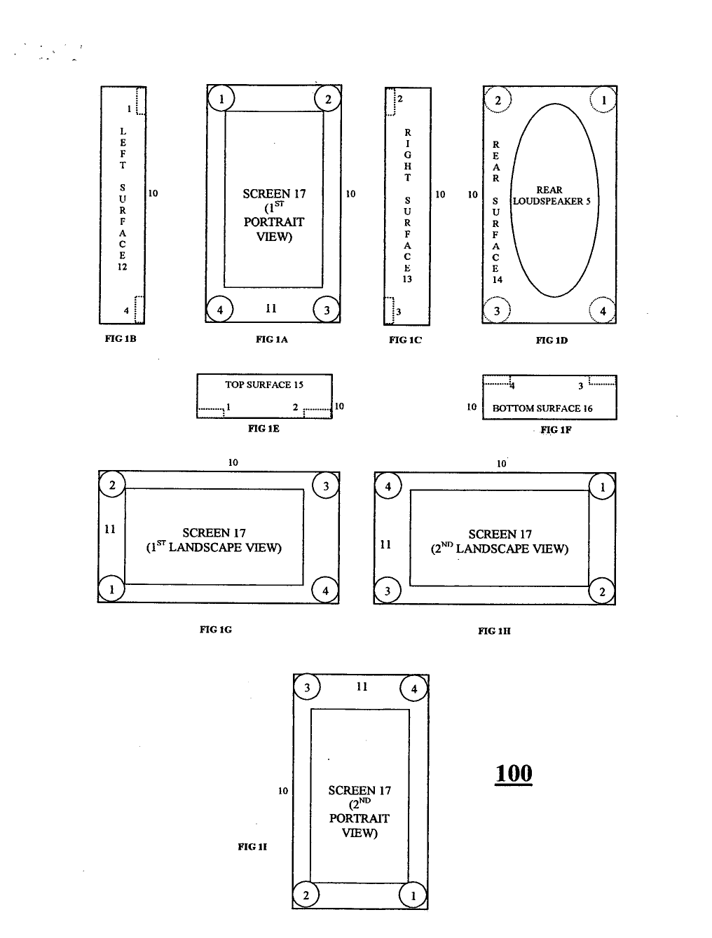

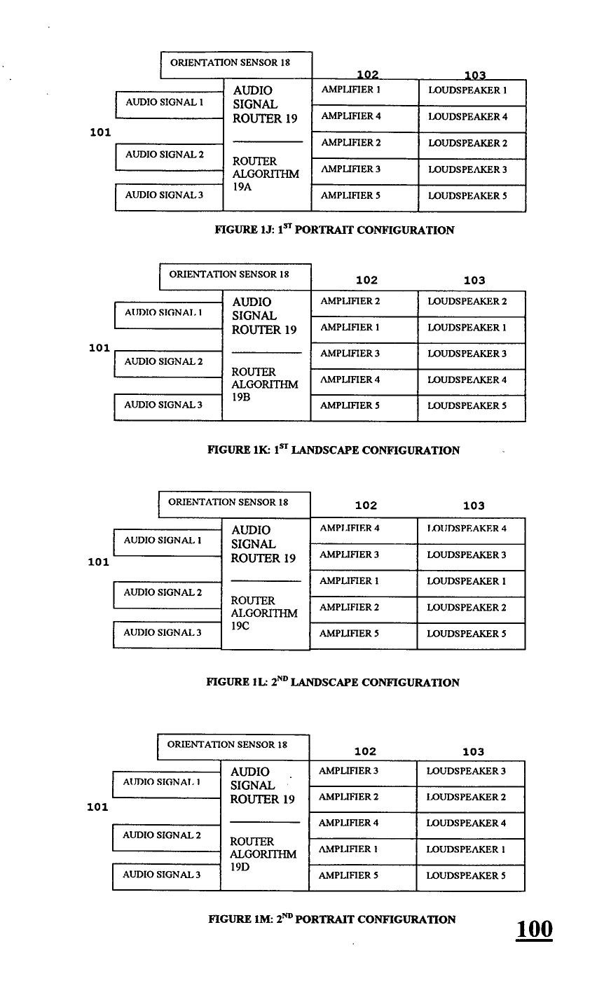

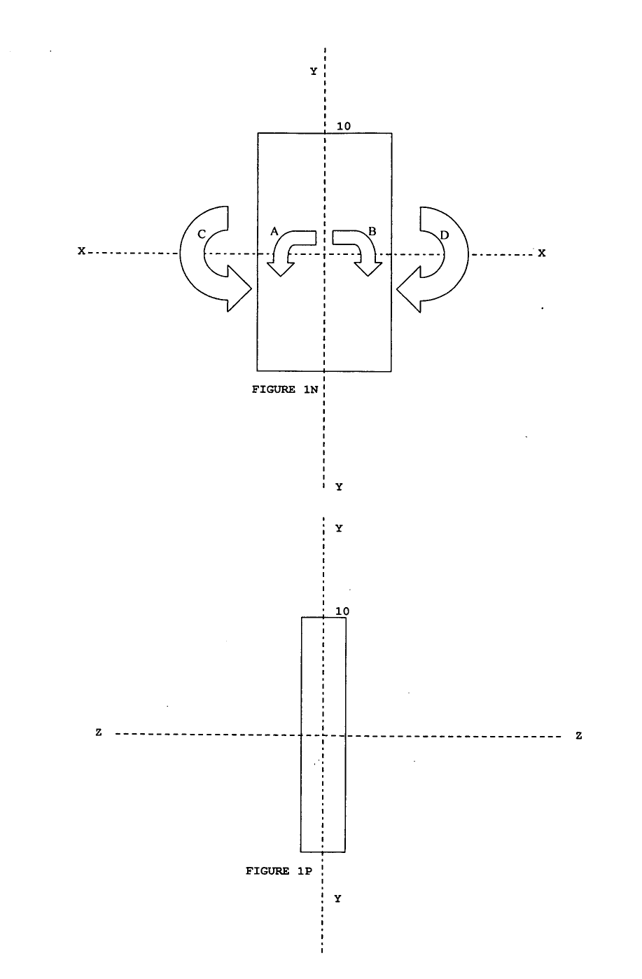

### FIGS. 1A-1I

FIGS. 1A through 1I show various views of Electronic Device 100 according to the present invention. FIG. 1A shows a front view of Electronic Device 100 in the 1^{ST} portrait configuration. FIG. 1B shows a left side view of Electronic Device 100. FIG. 1C shows a right side view of Electronic Device 100. FIG. 1D shows a rear view of Electronic Device 100. FIG. 1E shows a top view of Electronic Device 100. FIG. 1F shows a bottom view of Electronic Device 100. FIG. 1G shows a front view of Electronic Device 100 in the 1^{ST} landscape configuration. FIG. 1H shows a front view of Electronic Device 100 in the 2^{ND} landscape configuration. FIG. 1I shows a front view of Electronic Device 100 in the 2^{ND} portrait configuration.

FIG. 1A shows a front view of Electronic Device 100 in the 1^{ST} portrait configuration showing: housing 10; front surface 11; screen 17 in the 1^{ST} portrait view or right-side up portrait view; front facing sound producing device or loudspeaker 1 at or about the left upper corner of housing 10; front facing sound producing device or loudspeaker 2 at or about the right upper corner of housing 10; front facing sound producing device or loudspeaker 3 at or about the right lower corner of housing 10; and front facing sound producing device or loudspeaker 4 at or about the left lower corner of housing 10. Sound producing devices or loudspeakers 1 through 4 may be any known sound producing means which respond to respective input signals from respective amplifiers or other sources.

FIG. 1B shows a left side view of Electronic Device 100 showing: housing 10; left surface 12; sound producing device or loudspeaker 1 within and at or about the right upper portion of housing 10 in this view; and sound producing device or loudspeaker 4 within and at or about the right lower portion of housing 10 in this view.

FIG. 1C shows a right side view of Electronic Device 100 showing: housing 10; right surface 13; sound producing device or loudspeaker 2 within and at or about the left upper portion of housing 10 in this view; and sound producing device or loudspeaker 3 within and at or about the left lower portion of housing 10 in this view.

FIG. 1D shows a rear view of Electronic Device 100 showing: housing 10; rear surface 14; rear facing sound producing device or loudspeaker 1 at or about the right upper corner of housing 10 in this view; sound producing device or loudspeaker 2 within and at or about the left upper corner of housing 10 in this view; sound producing device or loudspeaker 3 within and at or about the left lower corner of housing 10 in this view; sound producing device or loudspeaker 4 within and at or about the right lower corner of housing 10 in this view; and sound producing device or loudspeaker 5 within and at or about rear surface 14. Sound producing device or loudspeakers 5 may be any known sound producing means which responds to respective input signals from a respective amplifier or other source.

FIG. 1E shows a top view of Electronic Device 100 showing: housing 10; top surface 15; sound producing device or loudspeaker 1 within and at or about the left lower portion of housing 10 in this view; and sound producing device or loudspeaker 2 within and at or about the right lower portion of housing 10 in this view.

FIG. 1F shows a bottom view of Electronic Device 100 showing: housing 10; bottom surface 16; sound producing device or loudspeaker 3 within and at or about the right upper portion of housing 10 in this view; and sound producing device or loudspeaker 4 within and at or about the left upper portion of housing 10 in this view.

FIG. 1G shows a front view of Electronic Device 100 as rotated 90 degrees counter-clockwise in the 1^{ST} landscape configuration showing: housing 10; front surface 11; screen 17 in the 1^{ST} landscape view or right-side up landscape view; sound producing device or loudspeaker 1 at or about the left lower corner of housing 10 in this view; sound producing device or loudspeaker 2 at or about the left upper corner of housing 10 in this view; sound producing device or loudspeaker 3 at or about the right upper corner of housing 10 in this view; and sound producing device or loudspeaker 4 at or about the right lower corner of housing 10 in this view.

FIG. 1H shows a front view of Electronic Device 100 as rotated 90 degrees clock-wise in the 2^{ND} landscape configuration showing: housing 10; front surface 11; screen 17 in the 2^{ND} landscape view or upside-down landscape view; sound producing device or loudspeaker 1 at or about the right upper corner of housing 10 in this view; sound producing device or loudspeaker 2 at or about the right lower corner of housing 10 in this view; sound producing device or loudspeaker 3 at or about the left lower corner of housing 10 in this view; and sound producing device or loudspeaker 4 at or about the left upper corner of housing 10 in this view.

FIG. 1I shows a front view of Electronic Device 100 as rotated either 180 degrees counter-clockwise or 180 degrees clockwise in the 2^{ND} portrait configuration showing: housing 10; front surface 11; screen 17 in the 2^{ND} portrait view or upside-down portrait view; sound producing device or loudspeaker 1 at or about the right lower corner of housing 10 in this view; sound producing device or loudspeaker 2 at or about the left lower corner of housing 10 in this view; sound producing device or loudspeaker 3 at or about the left upper corner of housing 10 in this view; and sound producing device or loudspeaker 4 at or about the right upper corner of housing 10 in this view.

### FIGS. 1J-1M

FIGS. 1J through 1M show the components which route the input audio signals in the various configurations of Electronic Device 100 according to the present invention. FIG. 1J shows the routing of input audio signals in the 1^{ST} portrait configuration. FIG. 1K shows the routing of input audio signals in the 1^{ST} landscape configuration. FIG. 1L shows the routing of input audio signals in the 2^{ND} landscape configuration. FIG. 1M shows routing of input audio signals in the 2^{ND} portrait configuration.

FIG. 1J shows the routing of input audio signals in the 1^{ST} portrait configuration of Electronic Device 100. FIG. 1J shows input audio signal source 101; audio signal router 19; amplifier array 102; loudspeaker array 103; and orientation sensor 18. Input audio signal source 101 provides audio signals 1 through 3 which may be pre-stored in Electronic Device 100 such as an I Tune database or other internal source. In the alternative, input audio signal source 101 provides audio signals 1 through 3 which may be received by Electronic Device 100 from an internet radio source, an FM station or other external source. Audio signal router 19 may receive or may have stored therein fixed or variable router algorithm 19A. Amplifier array 102 comprises amplifiers 1 through 5. Loudspeaker array 103 comprises loudspeakers 1 through 5. Orientation sensor 18 detects or determines the spatial or physical orientation of Electronic Device 100. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifiers 1 and 4 and thereafter to loudspeakers 1 and 4 to form what may be called the left channel output. Further, audio signal router 19 (under the control of router algorithm 19B) directs audio signal 2 to amplifiers 2 and 3 and thereafter to loudspeakers 2 and 3 to form what may be called the right channel output. Finally, audio signal router 19 (under the control of router algorithm 19B) directs audio signal 3 to amplifier 5 and thereafter to loudspeaker 5 to form what may be called the rear base channel output.

FIG. 1K shows the routing of input audio signals in the 1^{ST} landscape configuration of Electronic Device 100. FIG. 1K shows input audio signal source 101; audio signal router 19; amplifier array 102; loudspeaker array 103; and orientation sensor 18. Input audio signal source 101 provides audio signals 1 through 3 which may be pre-stored in Electronic Device 100 such as an I Tune database or other internal source. In the alternative, input audio signal source 101 may provide audio signals 1 through 3 which may be received by Electronic Device 100 from an internet radio source, an FM station or other external source. Audio signal router 19 may receive or may have stored therein fixed or variable router algorithm 19A. Amplifier array 102 comprises amplifiers 1 through 5. Loudspeaker array 103 comprises loudspeakers 1 through 5. Orientation sensor 18 detects or determines the spatial or physical orientation of Electronic Device 100. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifiers 2 and 1 and thereafter to loudspeakers 2 and 1 to form what may be called the left channel output. Further, audio signal router 19 (under the control of router algorithm 19B) directs audio signal 2 to amplifiers 3 and 4 and thereafter to loudspeakers 3 and 4 to form what may be called the right channel output. Finally, audio signal router 19 (under the control of router algorithm 19B) directs audio signal 3 to amplifier 5 and thereafter to loudspeaker 5 to form what may be called the rear base channel output.

FIG. 1L shows the routing of input audio signals in the 2^{nd} landscape configuration of Electronic Device 100. FIG. 1L shows input audio signal source 101; audio signal router 19; amplifier array 102; loudspeaker array 103; and orientation sensor 18. Input audio signal source 101 provides audio signals 1 through 3 which may be pre-stored in Electronic Device 100 such as an I Tune database or other internal source. In the alternative, input audio signal source 101 provides audio signals 1 through 3 which may be received by Electronic Device 100 from an internet radio source, an FM station or other H external source. Audio signal router 19 may receive or mat have stored therein fixed or variable router algorithm 19A. Amplifier array 102 comprises amplifiers 1 through 5. Loudspeaker array 103 comprises loudspeakers 1 through 5. Orientation sensor 18 detects or determines the spatial or physical orientation of Electronic Device 100. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifiers 4 and 3 and thereafter to loudspeakers 4 and 3 to form what may be called the left channel output. Further, audio signal router 19 (under the control of router algorithm 19B) directs audio signal 2 to amplifiers 1 and 2 and thereafter to loudspeakers 1 and 2 to form what may be called the right channel output. Finally, audio signal router 19 (under the control of router algorithm 19B) directs audio signal 3 to amplifier 5 and thereafter to loudspeaker 5 to form what may be called the rear base channel output.

FIG. 1M shows the routing of input audio signals in the 2^{nd} portrait configuration of Electronic Device 100. FIG. 1M shows input audio signal source 101; audio signal router 19; amplifier array 102; loudspeaker array 103; and orientation sensor 18. Input audio signal source 101 provides audio signals 1 through 3 which may be pre-stored in Electronic Device 100 such as an I Tune database or other internal source. In the alternative, input audio signal source 101 may provide audio signals 1 through 3 which may be received by Electronic Device 100 from an internet radio source, an FM station or other external source. Audio signal router 19 may receive or may have stored therein fixed or variable router algorithm 19A. Amplifier array 102 comprises amplifiers 1 through 5. Loudspeaker array 103 comprises loudspeakers 1 through 5. Orientation sensor 18 detects or determines the spatial or physical orientation of Electronic Device 100. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifiers 3 and 2 and thereafter to loudspeakers 3 and 2 to form what may be called the left channel output. Further, audio signal router 19 (under the control of router algorithm 19B) directs audio signal 2 to amplifiers 4 and 1 and thereafter to loudspeakers 4 and 1 to form what may be called the right channel output. Finally, audio signal router 19 (under the control of router algorithm 19B) directs audio signal 3 to amplifier 5 and thereafter to loudspeaker 5 to form what may be called the rear base channel output.

### FIGS. 1N And 1P

FIGS. 1N and 1P show the axes associated with Electronic Device 100. FIG. 1N shows housing 10 of Electronic Device 100; first horizontal axis or transverse axis X-X; and longitudinal or vertical axis Y-Y. FIG. 1P shows housing 10 of Electronic Device 100; longitudinal or vertical axis Y-Y; and second horizontal or front-rear axis Z-Z. In FIG. 1N, housing 10 is shown in the 1^{st} portrait configuration. Further, housing 10 may be moved or rotated 90 degrees counter-clockwise into the 1^{st} landscape configuration as shown by arrow A. Still further, housing 10 may be moved or rotated 90 degrees clockwise into the 2^{nd} landscape configuration as shown by arrow B. Finally, housing 10 may be moved or rotated 180 degrees counter-clockwise or 180 degrees clockwise into the 2^{nd} portrait configuration as shown by arrow C and arrow D.

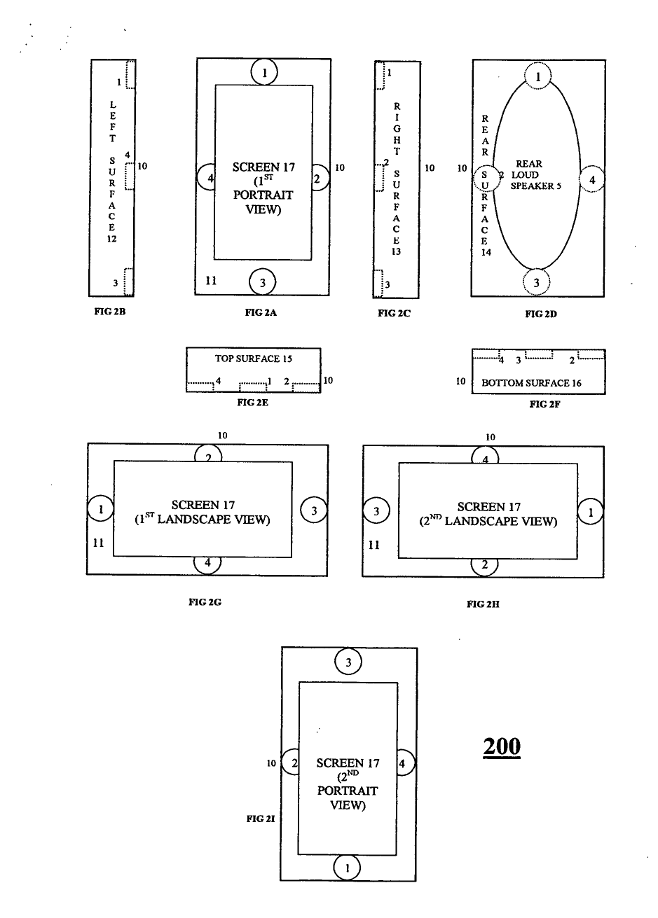

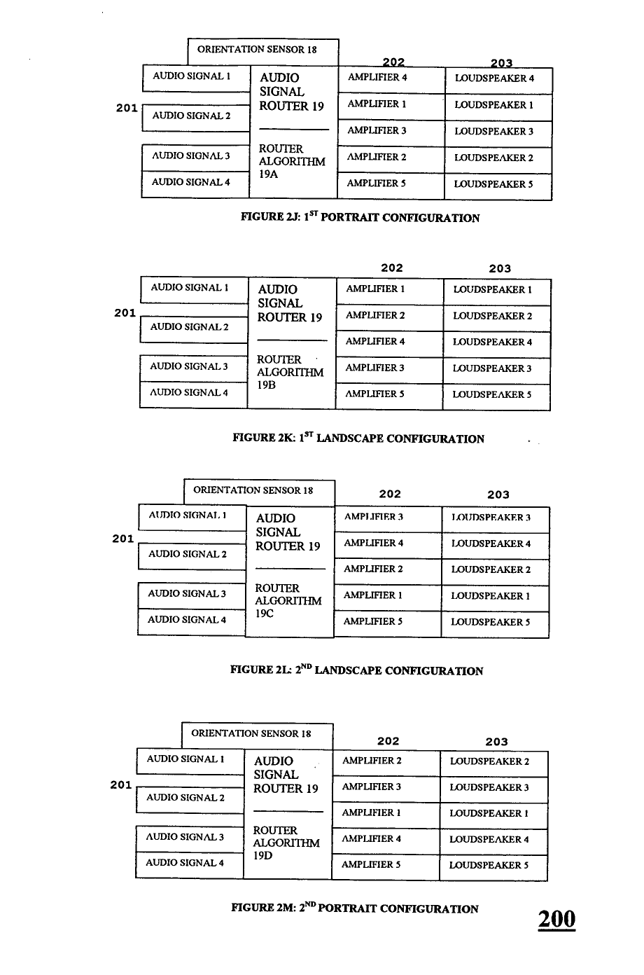

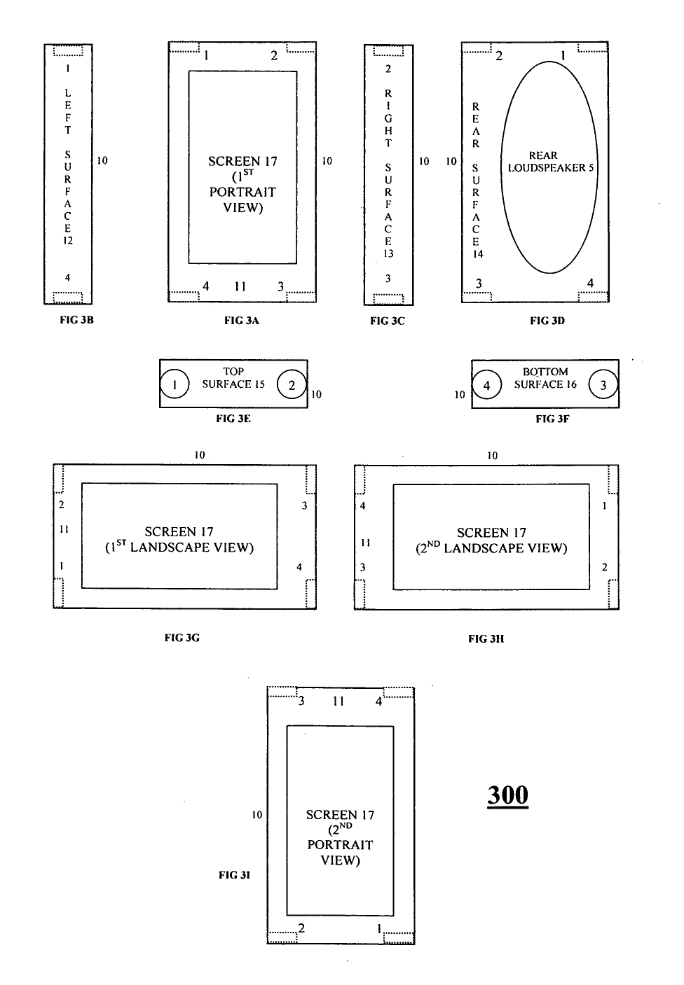

### FIGS. 2A-2I

FIGS. 2A through 2I show various views of Electronic Device 200 according to the present invention. FIG. 2A shows a front view of Electronic Device 200 in the 1^{ST} portrait configuration. FIG. 2B shows a left side view of Electronic Device 200. FIG. 2C shows a right side view of Electronic Device 200. FIG. 2D shows a rear view of Electronic Device 200. FIG. 2E shows a top view of Electronic Device 200. FIG. 2F shows a bottom view of Electronic Device 200. FIG. 2G shows a front view of Electronic Device 200 in the 1^{ST} landscape configuration. FIG. 2H shows a front view of Electronic Device 200 in the 2^{ND} landscape configuration. FIG. 2I shows a front view of Electronic Device 200 in the 2^{ND} portrait configuration.

FIG. 2A shows a front view of Electronic Device 200 in the 1^{ST} portrait configuration showing: housing 10; front surface 11; screen 17 in the 1^{ST} portrait view or right-side up portrait view; front facing sound producing device or loudspeaker 1 at or about the upper middle portion of housing 10; front facing sound producing device or loudspeaker 2 at or about the right middle portion of housing 10; front facing sound producing device or loudspeaker 3 at or about the lower middle portion of housing 10; and front facing sound producing device or loudspeaker 4 at or about the left middle portion of housing 10. Sound producing devices or loudspeakers 1 through 4 may be any known sound producing means which respond to respective input signals from respective amplifiers or other sources.

FIG. 2B shows a left side view of Electronic Device 200 showing: housing 10; left surface 12; sound producing device or loudspeaker 1 within and at or about the right upper portion of housing 10 in this view; sound producing device or loudspeaker 4 within and at or about the right middle portion of housing 10 in this view; and sound producing device or loudspeaker 3 within and at or about the right lower portion of housing 10 in this view.

FIG. 2C shows a right side view of Electronic Device 200 showing: housing 10; left surface 13; sound producing device or loudspeaker 1 within and at or about the left upper portion of housing 10 in this view; sound producing device or loudspeaker 2 within and at or about the left middle portion of housing 10 in this view; and sound producing device or loudspeaker 3 within and at or about the left lower portion of housing 10 in this view.

FIG. 2D shows a rear view of Electronic Device 200 showing: housing 10; rear surface 14; sound producing device or loudspeaker 1 within and at or about the upper middle portion of housing 10 in this view; sound producing device or loudspeaker 2 within and at or about the left middle portion of housing 10 in this view; sound producing device or loudspeaker 3 within and at or about the lower middle portion of housing 10 in this view; sound producing device or loudspeaker 4 within and at or about the right middle portion of housing 10 in this view; and rear facing sound producing device or loudspeaker 5 at or about rear surface 14. Sound producing device or loudspeaker 5 may be any known sound producing means which responds to respective input signals from a respective amplifier or other source.

FIG. 2E shows a top view of Electronic Device 200 showing: housing 10; top surface 15; sound producing device or loudspeaker 1 within and at or about the lower middle portion of housing 10 in this view; sound producing device or loudspeaker 2 within and at or about the right lower portion of housing 10 in this view; and sound producing device or loudspeaker 4 within and at or about the left lower portion of housing 10 in this view.

FIG. 2F shows a bottom view of Electronic Device 200 showing: housing 10; bottom surface 16; sound producing device or loudspeaker 2 within and at or about the right upper portion of housing 10 in this view; sound producing device or loudspeaker 3 within and at or about the middle upper portion of housing 10 in this view; and sound producing device or loudspeaker 4 within and at or about the left upper portion of housing 10 in this view.

FIG. 2G shows a front view of Electronic Device 200 as rotated 90 degrees counter-clockwise in the 1^{ST} landscape configuration showing: housing 10; front surface 11; screen 17 in the 1^{ST} landscape view or right-side up landscape view; sound producing device or loudspeaker 1 at or about the left middle portion of housing 10 in this view; sound producing device or loudspeaker 2 at or about the upper middle portion of housing 10 in this view; sound producing device or loudspeaker 3 at or about the right middle portion of housing 10 in this view; and sound producing device or loudspeaker 4 at or about the lower middle portion of housing 10 in this view.

FIG. 2H shows a front view of Electronic Device 200 as rotated 90 degrees clock-wise in the 2^{ND} landscape configuration showing: housing 10; front surface 11; screen 17 in the 2^{ND} landscape view or upside-down landscape view; sound producing device or loudspeaker 1 at or about the right middle portion of housing 10 in this view; sound producing device or loudspeaker 2 at or about the lower middle portion of housing 10 in this view; sound producing device or loudspeaker 3 at or about the left middle portion of housing 10 in this view; and sound producing device or loudspeaker 4 at or about the upper middle portion of housing 10 in this view.

FIG. 2I shows a front view of Electronic Device 200 as rotated either 180 degrees counter-clockwise or 180 degrees clockwise in the 2^{ND} portrait configuration showing: housing 10; front surface 11; screen 17 in the 2^{ND} portrait view or upside-down portrait view; sound producing device or loudspeaker 1 at or about the lower middle portion of housing 10 in this view; sound producing device or loudspeaker 2 at or about the left middle portion of housing 10 in this view; sound producing device or loudspeaker 3 at or about the upper middle portion of housing 10 in this view; and sound producing device or loudspeaker 4 at or about the right middle portion of housing 10 in this view.

### FIGS. 2J-2M

FIGS. 2J through 2M show the components which route the input audio signals in the various configurations of Electronic Device 200 according to the present invention. FIG. 2J shows the routing of input audio signals in the 1^{ST} portrait configuration. FIG. 2K shows the routing of input audio signals in the 1^{ST} landscape configuration. FIG. 2L shows the routing of input audio signals in the 2^{ND} landscape configuration. FIG. 2M shows routing of input audio signals in the 2^{ND} portrait configuration.

FIG. 2J shows the routing of input audio signals in the 1^{ST} portrait configuration of Electronic Device 200. FIG. 2J shows input audio signal source 201; audio signal router 19; amplifier array 202; loudspeaker array 203; and orientation sensor 18. Input audio signal source 201 provides audio signals 1 through 4 which may be pre-stored in Electronic Device 200 such as an I Tune database or other internal source. In the alternative, input audio signal source 201 provides audio signals 1 through 4 which may be received by Electronic Device 200 from an internet radio source, an FM station or other external source. Audio signal router 19 may receive or may have stored therein fixed or variable router algorithm 19A. Amplifier array 202 comprises amplifiers 1 through 5. Loudspeaker array 203 comprises loudspeakers 1 through 5. Orientation sensor 18 detects or determines the spatial or physical orientation of Electronic Device 200. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifier 4 and thereafter to loudspeaker 4 to form what may be called the left channel output. Further, audio signal router 19 (under the control of router algorithm 19B) directs audio signal 2 to amplifiers 1 and 3 and thereafter to loudspeakers 1 and 3 to form what may be called the center channel output. Further, audio signal router 19 (under the control of router algorithm 19B) directs audio signal 3 to amplifier 2 and thereafter to loudspeaker 2 to form what may be called the right channel output. Finally, audio signal router 19 (under the control of router algorithm 19B) directs audio signal 4 to amplifier 5 and thereafter to loudspeaker 5 to form what may be called the rear base channel output.

FIG. 2K shows the routing of input audio signals in the 1^{ST} landscape configuration of Electronic Device 200. FIG. 2K shows input audio signal source 201; audio signal router 19; amplifier array 202; loudspeaker array 203; and orientation sensor 18. Input audio signal source 201 provides audio signals 1 through 4 which may be pre-stored in Electronic Device 200 such as an I Tune database or other internal source. In the alternative, input audio signal source 201 provides audio signals 1 through 4 which may be received by Electronic Device 200 such as from an internet radio source, an FM station or other external source. Audio signal router 19 may receive or may have stored therein fixed or variable router algorithm 19A. Amplifier array 202 comprises amplifiers 1 through 5. Loudspeaker array 203 comprises loudspeakers 1 through 5. Orientation sensor 18 detects or determines the spatial or physical orientation of Electronic Device 200. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifier 1 and thereafter to loudspeaker 1 to form what may be called the left channel output. Further, audio signal router 19 (under the control of router algorithm 19B) directs audio signal 2 to amplifiers 2 and 4 and thereafter to loudspeakers 2 and 4 to form what may be called the center channel output. Further, audio signal router 19 (under the control of router algorithm 19B) directs audio signal 3 to amplifier 3 and thereafter to loudspeaker 3 to form what may be called the right channel output. Finally, audio signal router 19 (under the control of router algorithm 19B) directs audio signal 4 to amplifier 5 and thereafter to loudspeaker 5 to form what may be called the rear base channel output.

FIG. 2L shows the routing of input audio signals in the 2^{nd} landscape configuration of Electronic Device 200. FIG. 2L shows input audio signal source 201; audio signal router 19; amplifier array 202; loudspeaker array 203; and orientation sensor 18. Input audio signal source 201 provides audio signals 1 through 4 which may be pre-stored in Electronic Device 200 such as an I Tune database or other internal source. In the alternative, input audio signal source 201 provides audio signals 1 through 4 which may be received by Electronic Device 200 from an internet radio source, an FM station or other external source. Audio signal router 19 may receive or may have stored therein fixed or variable router algorithm 19A. Amplifier array 202 comprises amplifiers 1 through 5. Loudspeaker array 203 comprises loudspeakers 1 through 5. Orientation sensor 18 detects or determines the spatial or physical orientation of Electronic Device 200. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifier 3 and thereafter to loudspeaker 3 to form what may be called the left channel output. Further, audio signal router 19 (under the control of router algorithm 19B) directs audio signal 2 to amplifiers 4 and 2 and thereafter to loudspeakers 4 and 2 to form what may be called the front center channel output. Further, audio signal router 19 (under the control of router algorithm 19B) directs audio signal 3 to amplifier 1 and thereafter to loudspeaker 1 to form what may be called the right channel output. Finally, audio signal router 19 (under the control of router algorithm 19B) directs audio signal 4 to amplifier 5 and thereafter to loudspeaker 5 to form what may be called the rear base channel output.

FIG. 2M shows the routing of input audio signals in the 2^{nd} portrait configuration of Electronic Device 200. FIG. 2M shows input audio signal source 201; audio signal router 19; amplifier array 202; loudspeaker array 203; and orientation sensor 18. Input audio signal source 201 provides audio signals 1 through 4 which may be pre-stored in Electronic Device 200 such as an I Tune database or other internal source. In the alternative, input audio signal source 201 provides audio signals 1 through 4 which may be received by Electronic Device 200 from an internet radio source, an FM station or other external source. Audio signal router 19 may receive or may have stored therein fixed or variable router algorithm 19A. Amplifier array 202 comprises amplifiers 1 through 5. Loudspeaker array 203 comprises loudspeakers 1 through 5. Orientation sensor 18 detects or determines the spatial or physical orientation of Electronic Device 200. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifier 2 and thereafter to loudspeaker 2 to form what may be called the left channel output. Further, audio signal router 19 (under the control of router algorithm 19B) directs audio signal 2 to amplifiers 3 and 1 and thereafter to loudspeakers 3 and 1 to form what may be called the front center channel output. Further, audio signal router 19 (under the control of router algorithm 19B) directs audio signal 3 to amplifier 4 and thereafter to loudspeaker 4 to form what may be called the right channel output. Finally, audio signal router 19 (under the control of router algorithm 19B) directs audio signal 4 to amplifier 5 and thereafter to loudspeaker 5 to form what may be called the rear base channel output.

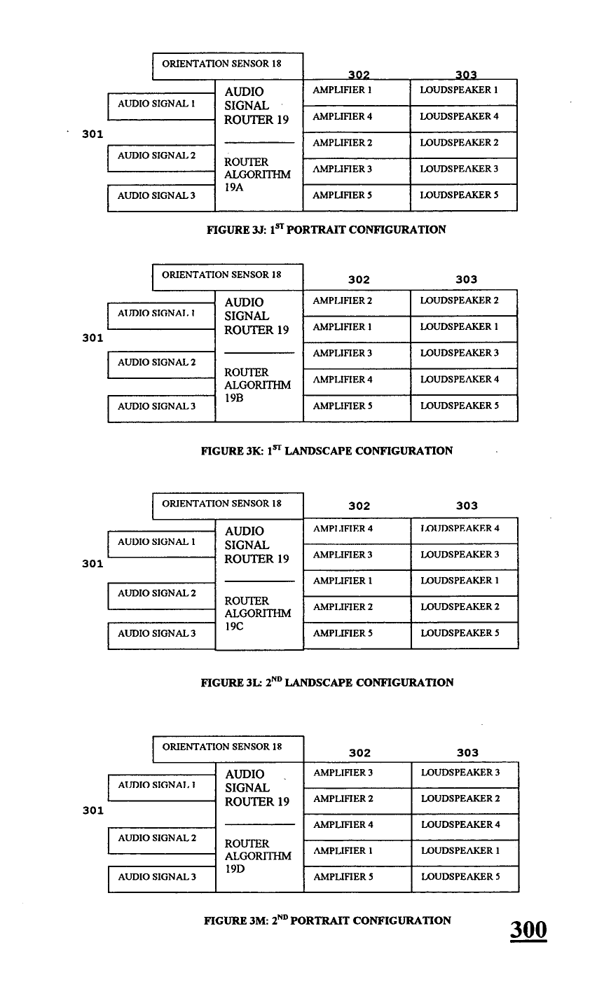

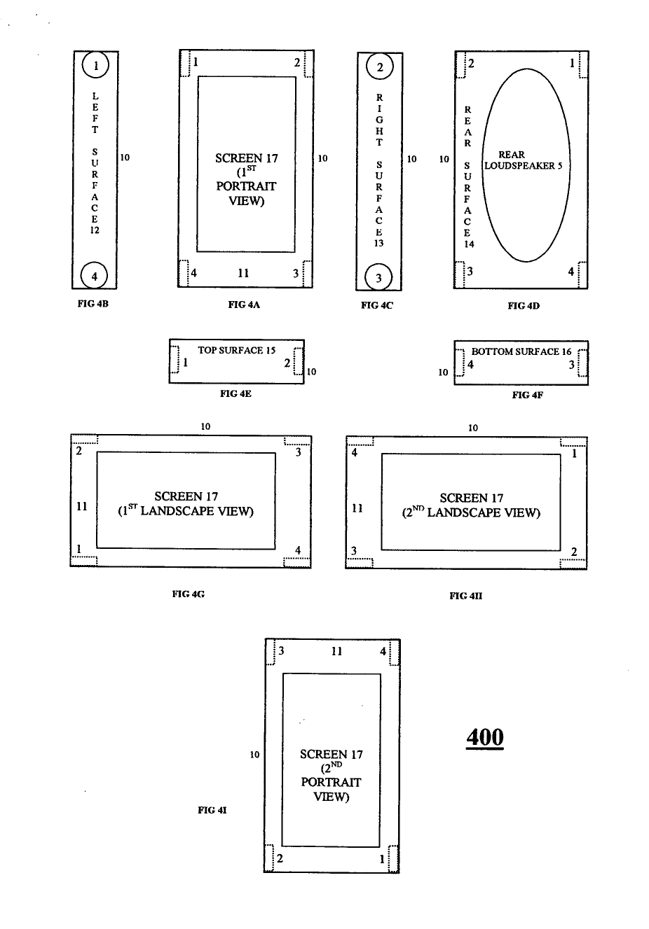

### FIGS. 3A-3I

FIGS. 3A through 3I show various views of Electronic Device 300 according to the present invention. FIG. 3A shows a front view of Electronic Device 300 in the 1^{ST} portrait configuration. FIG. 3B shows a left side view of Electronic Device 300. FIG. 3C shows a right side view of Electronic Device 300. FIG. 3D shows a rear view of Electronic Device 300. FIG. 3E shows a top view of Electronic Device 300. FIG. 3F shows a bottom view of Electronic Device 300. FIG. 3G shows a front view of Electronic Device 300 in the 1^{ST} landscape configuration. FIG. 3H shows a front view of Electronic Device 300 in the 2^{nd} landscape configuration. FIG. 3I shows a front view of Electronic Device 300 in the 2^{ND} portrait configuration.

FIG. 3A shows a front view of Electronic Device 300 in the 1^{ST} portrait configuration showing: housing 10; front surface 11; screen 17 in the 1^{ST} portrait view or right-side up portrait view; upward facing sound producing device or loudspeaker 1 within and at or about the left upper portion of housing 10; upward facing sound producing device or loudspeaker 2 within and at or about the right upper portion of housing 10; downward facing sound producing device or loudspeaker 3 within and at or about the right lower portion of housing 10; and downward facing sound producing device or loudspeaker 4 within and at or about the left lower portion of housing 10. Sound producing devices or loudspeakers 1 through 4 may be any known sound producing means which respond to respective input signals from respective amplifiers or other sources.

FIG. 3B shows a left side view of Electronic Device 300 showing: housing 10; left surface 12; sound producing device or loudspeaker 1 within and at or about the upper middle portion of housing 10 in this view; and sound producing device or loudspeaker 4 within and at or about the lower middle portion of housing 10 in this view.

FIG. 3C shows a right side view of Electronic Device 300 showing: housing 10; right surface 13; sound producing device or loudspeaker 2 within and at or about the upper middle portion of housing 10 in this view; and sound producing device or loudspeaker 3 within and at or about the lower middle portion of housing 10 in this view.

FIG. 3D shows a rear view of Electronic Device 300 showing: housing 10; rear surface 14; sound producing device or loudspeaker 1 within and at or about the right upper portion of housing 10 in this view; sound producing device or loudspeaker 2 within and at or about the left upper portion of housing 10 in this view; sound producing device or loudspeaker 3 within and at or about the left lower portion of housing 10 in this view; sound producing device or loudspeaker 4 at within and or about the right lower portion of housing 10 in this view; and rear facing sound producing device or loudspeaker 5 at or about rear surface 14. Sound producing device or loudspeaker 5 may be any known sound producing means which responds to respective input signals from a respective amplifier or other source.

FIG. 3E shows a top view of Electronic Device 300 showing: housing 10; top surface 15; sound producing device or loudspeaker 1 at or about the left middle portion of housing 10 in this view; and sound producing device or loudspeaker 2 at or about the right middle portion of housing 10 in this view.

FIG. 3F shows a bottom view of Electronic Device 300 showing: housing 10; bottom surface 16; sound producing device or loudspeaker 3 at or about the right middle portion of housing 10 in this view; and sound producing device or loudspeaker 4 at or about the left middle portion of housing 10 in this view.

FIG. 3G shows a front view of Electronic Device 300 as rotated 90 degrees counter-clockwise in the 1^{ST} landscape configuration showing: housing 10; front surface 11; screen 17 in the 1^{ST} landscape view or right-side up landscape view; sound producing device or loudspeaker 1 within and at or about the left lower portion of housing 10 in this view; sound producing device or loudspeaker 2 within and at or about the left upper portion of housing 10 in this view; sound producing device or loudspeaker 3 within and at or about the right upper portion of housing 10 in this view; and sound producing device or loudspeaker 4 within and at or about the right lower portion of housing 10 in this view.

FIG. 3H shows a front view of Electronic Device 300 as rotated 90 degrees clock-wise in the 2^{ND} landscape configuration showing: housing 10; front surface 11; screen 17 in the 2^{ND} landscape view or upside-down landscape view; sound producing device or loudspeaker 1 within and at or about the right upper portion of housing 10 in this view; sound producing device or loudspeaker 2 within and at or about the right lower portion of housing 10 in this view; sound producing device or loudspeaker 3 within and at or about the left lower portion of housing 10 in this view; and sound producing device or loudspeaker 4 within and at or about the left upper portion of housing 10 in this view.

FIG. 3I shows a front view of Electronic Device 300 as rotated either 180 degrees counter-clockwise or 180 degrees clockwise in the 2^{ND} portrait configuration showing: housing 10; front surface 11; screen 17 in the 2^{ND} portrait view or upside-down portrait view; sound producing device or loudspeaker 1 within and at or about the right lower portion of housing 10 in this view; sound producing device or loudspeaker 2 within and at or about the left lower portion of housing 10 in this view; sound producing device or loudspeaker 3 within and at or about the left upper portion of housing 10 in this view; and sound producing device or loudspeaker 4 at or about the right upper portion of housing 10 in this view.

### FIGS. 3J-3M

FIGS. 3J through 3M show the routing of the input audio signals in the various configurations of Electronic Device 300 according to the present invention. FIG. 3J shows the routing of input audio signals in the 1^{ST} portrait configuration. FIG. 3K shows the routing of input audio signals in the 1^{ST} landscape configuration. FIG. 3L shows the routing of input audio signals in the 2^{ND} landscape configuration. FIG. 3M shows the routing of input audio signals in the 2^{ND} portrait configuration.

FIG. 3J shows the routing of input audio signals in the 1^{ST} portrait configuration of Electronic Device 300. FIG. 3J shows input audio signal source 301; audio signal router 19; amplifier array 302; loudspeaker array 303; and orientation sensor 18. Input audio signal source 301 provides audio signals 1 through 3 which may be pre-stored in Electronic Device 300 such as an I Tune database or other internal source. In the alternative, input audio signal source 301 provides audio signals 1 through 3 which may be received by Electronic Device 300 from an internet radio source, an FM station or other external source. Audio signal router 19 may receive or may have stored therein fixed or variable router algorithm 19A. Amplifier array 302 comprises amplifiers 1 through 5. Loudspeaker array 303 comprises loudspeakers 1 through 5. Orientation sensor 18 detects or determines the spatial or physical orientation of Electronic Device 300. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifiers 1 and 4 and thereafter to loudspeakers 1 and 4 to form what may be called the left channel output. Further, audio signal router 19 (under the control of router algorithm 19B) directs audio signal 2 to amplifiers 2 and 3 and thereafter to loudspeakers 2 and 3 to form what may be called the right channel output. Finally, audio signal router 19 (under the control of router algorithm 19B) directs audio signal 3 to amplifier 5 and thereafter to loudspeaker 5 to form what may be called the rear base channel output.

FIG. 3K shows the routing of input audio signals in the 1^{ST} landscape configuration of Electronic Device 300. FIG. 3K shows input audio signal source 301; audio signal router 19; amplifier array 302; loudspeaker array 303; and orientation sensor 18. Input audio signal source 301 provides audio signals 1 through 3 which may be pre-stored in Electronic Device 300 such as an I Tune database or other internal source. In the alternative, input audio signal source 301 may provide audio signals 1 through 3 which may be received by Electronic Device 300 from an internet radio source, an FM station or other external source. Audio signal router 19 may receive or may have stored therein fixed or variable router algorithm 19A. Amplifier array 302 comprises amplifiers 1 through 5. Loudspeaker array 303 comprises loudspeakers 1 through 5. Orientation sensor 18 detects or determines the spatial or physical orientation of Electronic Device 300. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifiers 2 and 1 and thereafter to loudspeakers 2 and 1 to form what may be called the left channel output. Further, audio signal router 19 (under the control of router algorithm 19B) directs audio signal 2 to amplifiers 3 and 4 and thereafter to loudspeakers 3 and 4 to form what may be called the right channel output. Finally, audio signal router 19 (under the control of router algorithm 19B) directs audio signal 3 to amplifier 5 and thereafter to loudspeaker 5 to form what may be called the rear base channel output.

FIG. 3L shows the routing of input audio signals in the 2^{nd} landscape configuration of Electronic Device 300. FIG. 3L shows input audio signal source 301; audio signal router 19; amplifier array 302; loudspeaker array 303; and orientation sensor 18. Input audio signal source 301 provides audio signals 1 through 3 which may be pre-stored in Electronic Device 300 such as an I Tune database or other internal source. In the alternative, input audio signal source 301 may provide audio signals 1 through 3 which may be received by Electronic Device 300 from an internet radio source, an FM station or other external source. Audio signal router 19 may receive or may have stored therein fixed or variable router algorithm 19A. Amplifier array 302 comprises amplifiers 1 through 5. Loudspeaker array 303 comprises loudspeakers 1 through 5. Orientation sensor 18 detects or determines the spatial or physical orientation of Electronic Device 300. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifiers 4 and 3 and thereafter to loudspeakers 4 and 3 to form what may be called the left channel output. Further, audio signal router 19 (under the control of router algorithm 19B) directs audio signal 2 to amplifiers 1 and 2 and thereafter to loudspeakers 1 and 2 to form what may be called the right channel output. Finally, audio signal router 19 (under the control of router algorithm 19B) direct audio signal 3 to amplifier 5 and thereafter to loudspeaker 5 to form what may be called the rear base channel output.

FIG. 3M shows the routing of input audio signals in the 2^{nd} portrait configuration of Electronic Device 300. FIG. 3M shows input audio signal source 301; audio signal router 19; amplifier array 302; loudspeaker array 303; and orientation sensor 18. Input audio signal source 301 provides audio signals 1 through 3 which may be pre-stored in Electronic Device 300 such as an I Tune database or other internal source. In the alternative, input audio signal source 301 may provide audio signals 1 through 3 which may be received by Electronic Device 300 from an internet radio source, an FM station or other external source. Audio signal router 19 may receive or may have stored therein fixed or variable router algorithm 19A. Amplifier array 302 comprises amplifiers 1 through 5. Loudspeaker array 303 comprises loudspeakers 1 through 5. Orientation sensor 18 detects or determines the spatial or physical orientation of Electronic Device 300. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifiers 3 and 2 and thereafter to loudspeakers 3 and 2 to form what may be called the left channel output. Further, audio signal router 19 (under the control of router algorithm 19B) directs audio signal 2 to amplifiers 4 and 1 and thereafter to loudspeakers 4 and 1 to form what may be called the right channel output. Finally, audio signal router 19 (under the control of router algorithm 19B) directs audio signal 3 to amplifier 5 and thereafter to loudspeaker 5 to form what may be called the rear base channel output.

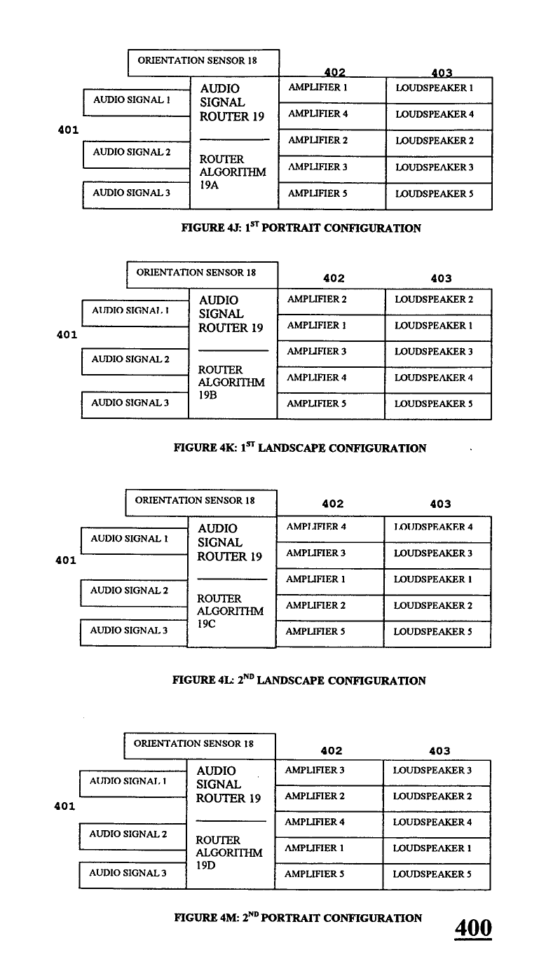

### FIGS. 4A-4I

FIGS. 4A through 4I show various views of Electronic Device 400 according to the present invention. FIG. 4A shows a front view of Electronic Device 400 in the 1^{ST} portrait configuration. FIG. 4B shows a left side view of Electronic Device 400. FIG. 4C shows a right side view of Electronic Device 400. FIG. 4D shows a rear view of Electronic Device 400. FIG. 4E shows a top view of Electronic Device 400. FIG. 4F shows a bottom view of Electronic Device 400. FIG. 4G shows a front view of Electronic Device 400 in the 1^{ST} landscape configuration. FIG. 4H shows a front view of Electronic Device 400 in the 2^{ND} landscape configuration. FIG. 4I shows a front view of Electronic Device 400 in the 2′ portrait configuration.

FIG. 4A shows a front view of Electronic Device 400 in the 1^{ST} portrait configuration showing: housing 10; front surface 11; screen 17 in the 1^{ST} portrait view or right-side up portrait view; left facing sound producing device or loudspeaker 1 within and at or about the left upper portion of housing 10; right facing sound producing device or loudspeaker 2 within and at or about the right upper portion of housing 10; right facing sound producing device or loudspeaker 3 within and at or about the right lower portion of housing 10; and left facing sound producing device or loudspeaker 4 within and at or about the left upper portion of housing 10. Sound producing devices or loudspeakers 1 through 4 may be any known sound producing means which respond to respective input signals from respective amplifiers or other sources.

FIG. 4B shows a left side view of Electronic Device 400 showing: housing 10; left surface 12; sound producing device or loudspeaker 1 at or about the upper middle portion of housing 10 in this view; and sound producing device or loudspeaker 4 at or about the lower middle portion of housing 10 in this view.

FIG. 4C shows a right side view of Electronic Device 400 showing: housing 10; right surface 13; sound producing device or loudspeaker 2 at or about the upper middle portion of housing 10 in this view; and sound producing device or loudspeaker 3 at or about the lower middle portion of housing 10 in this view.

FIG. 4D shows a rear view of Electronic Device 400 showing: housing 10; rear surface 14; sound producing device or loudspeaker 1 within and at or about the right upper portion of housing 10 in this view; sound producing device or loudspeaker 2 within and at or about the left upper portion of housing 10 in this view; sound producing device or loudspeaker 3 within and at or about the left lower portion of housing 10 in this view; sound producing device or loudspeaker 4 within and at or about the right lower portion of housing 10 in this view; and rear facing sound producing device or loudspeaker 5 at or about rear surface 14. Sound producing device or loudspeaker 5 may be any known sound producing means which responds to respective input signals from a respective amplifier or other source.

FIG. 4E shows a top view of Electronic Device 400 showing: housing 10; top surface 15; sound producing device or loudspeaker 1 within and at or about the left middle portion of housing 10 in this view; and sound producing device or loudspeaker 2 within and at or about the right middle portion of housing 10 in this view.

FIG. 4F shows a bottom view of Electronic Device 400 showing: housing 10; bottom surface 16; sound producing device or loudspeaker 3 within and at or about the right middle portion of housing 10 in this view; and sound producing device or loudspeaker 4 within and at or about the left middle portion of housing 10 in this view.

FIG. 4G shows a front view of Electronic Device 400 as rotated 90 degrees counter-clockwise in the 1^{ST} landscape configuration showing: housing 10; front surface 11; screen 17 in the 1^{ST} landscape view or right-side up landscape view; sound producing device or loudspeaker 1 within and at or about the right lower portion of housing 10 in this view; sound producing device or loudspeaker 2 within and at or about the left upper portion of housing 10 in this view; sound producing device or loudspeaker 3 within and at or about the right upper portion of housing 10 in this view; and sound producing device or loudspeaker 4 within and at or about the right lower portion of housing 10 in this view.

FIG. 4H shows a front view of Electronic Device 400 as rotated 90 degrees clock-wise in the 2^{ND} landscape configuration showing: housing 10; front surface 11; screen 17 in the 2^{ND} landscape view or upside-down landscape view; sound producing device or loudspeaker 1 within and at or about the right upper portion of housing 10 in this view; sound producing device or loudspeaker 2 within and at or about the right lower portion of housing 10 in this view; sound producing device or loudspeaker 3 within and at or about the left lower portion of housing 10 in this view; and sound producing device or loudspeaker 4 within and at or about the left upper portion of housing 10 in this view.

FIG. 4I shows a front view of Electronic Device 400 as rotated either 180 degrees counter-clockwise or 180 degrees clockwise in the 2^{ND} portrait configuration showing: housing 10; front surface 11; screen 17 in the 2^{ND} portrait view or upside-down portrait view; sound producing device or loudspeaker 1 within and at or about the right lower portion of housing 10 in this view; sound producing device or loudspeaker 2 within and at or about the left lower portion of housing 10 in this view; sound producing device or loudspeaker 3 within and at or about the left upper portion of housing 10 in this view; and sound producing device or loudspeaker 4 within and at or about the right upper portion of housing 10 in this view.

### FIGS. 4J-4M

FIGS. 4J through 4M show the routing of the input audio signals in the various configurations of Electronic Device 400 according to the present invention. FIG. 4J shows the routing of input audio signals in the 1^{ST} portrait configuration. FIG. 4K shows the routing of input audio signals in the 1^{ST} landscape configuration. FIG. 4L shows the routing of input audio signals in the 2^{ND} landscape configuration. FIG. 4M shows the routing of input audio signals in the 2^{ND} portrait configuration.

FIG. 4J shows the routing of input audio signals in the 1^{ST} portrait configuration of Electronic Device 400. FIG. 4J shows input audio signal source 401; audio signal router 19; amplifier array 402; loudspeaker array 403; and orientation sensor 18. Input audio signal source 401 provides audio signals 1 through 3 which may be pre-stored in Electronic Device 400 such as an I Tune database or other internal source. In the alternative, input audio signal source 401 provides audio signals 1 through 3 which may be received by Electronic Device 400 from an internet radio source, an FM station or other external source. Audio signal router 19 may receive or may have stored therein fixed or variable router algorithm 19A. Amplifier array 402 comprises amplifiers 1 through 5. Loudspeaker array 403 comprises loudspeakers 1 through 5. Orientation sensor 18 detects or determines the spatial or physical orientation of Electronic Device 400. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifiers 1 and 4 and thereafter to loudspeakers 1 and 4 to form what may be called the left channel output. Further, audio signal router 19 (under the control of router algorithm 19B) directs audio signal 2 to amplifiers 2 and 3 and thereafter to loudspeakers 2 and 3 to form what may be called the right channel output. Finally, audio signal router 19 (under the control of router algorithm 19B) directs audio signal 3 to amplifier 5 and thereafter to loudspeaker 5 to form what may be called the rear base channel output.

FIG. 4K shows the routing of input audio signals in the 1^{ST} landscape configuration of Electronic Device 400. FIG. 4K shows input audio signal source 401; audio signal router 19; amplifier array 402; loudspeaker array 403; and orientation sensor 18. Input audio signal source 401 provides audio signals 1 through 3 which may be pre-stored in Electronic Device 400 such as an I Tune database or other internal source. In the alternative, input audio signal source 401 may provide audio signals 1 through 3 which may be received by Electronic Device 400 from an internet radio source, an FM station or other external source. Audio signal router 19 may receive or may have stored therein fixed or variable router algorithm 19A. Amplifier array 402 comprises amplifiers 1 through 5. Loudspeaker array 403 comprises loudspeakers 1 through 5. Orientation sensor 18 detects or determines the spatial or physical orientation of Electronic Device 400. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifiers 2 and 1 and thereafter to loudspeakers 2 and 1 to form what may be called the left channel output. Further, audio signal router 19 (under the control of router algorithm 19B) directs audio signal 2 to amplifiers 3 and 4 and thereafter to loudspeakers 3 and 4 to form what may be called the right channel output. Finally, audio signal router 19 (under the control of router algorithm 19B) directs audio signal 3 to amplifier 5 and thereafter to loudspeaker 5 to form what may be called the rear base channel output.

FIG. 4L shows the routing of input audio signals in the 2^{nd} landscape configuration of Electronic Device 400. FIG. 4L shows input audio signal source 401; audio signal router 19; amplifier array 402; loudspeaker array 403; and orientation sensor 18. Input audio signal source 401 provides audio signals 1 through 3 which may be pre-stored in Electronic Device 400 such as an I Tune database or other internal source. In the alternative, input audio signal source 401 provides audio signals 1 through 3 which may be received by Electronic Device 400 from an internet radio source, an FM station or other external source. Audio signal router 19 may receive or may have stored therein fixed or variable router algorithm 19A. Amplifier array 402 comprises amplifiers 1 through 5. Loudspeaker array 403 comprises loudspeakers 1 through 5. Orientation sensor 18 detects or determines the spatial or physical orientation of Electronic Device 400. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifiers 4 and 3 and thereafter to loudspeakers 4 and 3 to form what may be called the left channel output. Further, audio signal router 19 (under the control of router algorithm 19B) directs audio signal 2 to amplifiers 1 and 2 and thereafter to loudspeakers 1 and 2 to form what may be called the right channel output. Finally, audio signal router 19 (under the control of router algorithm 19B) directs audio signal 3 to amplifier 5 and thereafter to loudspeaker 5 to form what may be called the rear base channel output.

FIG. 4M shows the routing of input audio signals in the 2^{nd} portrait configuration of Electronic Device 400. FIG. 4M shows input audio signal source 401; audio signal router 19; amplifier array 402; loudspeaker array 403; and orientation sensor 18. Input audio signal source 401 provides audio signals 1 through 3 which may be pre-stored in Electronic Device 400 such as an I Tune database or other internal source. In the alternative, input audio signal source 401 provides audio signals 1 through 3 which may be received by Electronic Device 400 from an internet radio source, an FM station or other external source. Audio signal router 19 may receive or may have stored therein fixed or variable router algorithm 19A. Amplifier array 402 comprises amplifiers 1 through 5. Loudspeaker array 403 comprises loudspeakers 1 through 5. Orientation sensor 18 detects or determines the spatial or physical orientation of Electronic Device 400. Orientation sensor 18 may be a position sensor, a motion sensor or an acceleration sensor according to the cited prior art references of Abe, Robin and Zhao. By way of example only (and not by way of limitation) audio signal router 19 (under the control of router algorithm 19B) directs audio signal 1 to amplifiers 3 and 2 and thereafter to loudspeakers 3 and 2 to form what may be called the left channel output. Further, audio signal router 19 (under the control of router algorithm 19B) directs audio signal 2 to amplifiers 4 and 1 and thereafter to loudspeakers 4 and 1 to form what may be called the right channel output. Finally, audio signal router 19 (under the control of router algorithm 19B) directs audio signal 3 to amplifier 5 and thereafter to loudspeaker 5 to form what may be called the rear base channel output.

### FIG. 5

FIG. 5 shows the components which route the input audio signals in the various configurations of Electronic Device 500 according to the present invention.

FIG. 5 shows input audio signal source 20; audio signal router 19; amplifier array 21; loudspeaker array 22; and orientation sensor 18. Input audio signal source 20 provides audio signals 1, 2, . . . X−1, and X which may be pre-stored in Electronic Device 500 such as an I Tune database or other internal source. In the alternative, input audio signal source 20 provides audio signals 1, 2, . . . X−1, and X which may be received by Electronic Device 500 from an internet radio source, an FM station or other external source. Audio signal router 19 may receive or may have stored therein fixed or variable router algorithms 1, 2, 3, and 4. Amplifier array 21 comprises amplifiers 1, 2, . . . Y−1, and Y. Loudspeaker array 22 comprises loudspeakers 1, 2, . . . Y−1, and Y. Orientation sensor 18 detects or determines the spatial or physical orientation of Electronic Device 500. Orientation sensor 18 may be a position sensor or detector, a motion sensor or detector, or an acceleration sensor or detector according to the cited prior art references of Abe, Robin and Zhao. Router algorithm 1 directs a first combination of input audio signals 1, 2, . . . X−1, and X to respective amplifiers 1, 2, . . . Y−1, and Y and then to respective loudspeakers 1, 2, . . . Y−1, and Y in the 1^{st} portrait configuration of Electronic Device 500. Router algorithm 2 directs a second combination of input audio signals 1, 2, . . . X−1, and X to respective amplifiers 1, 2, . . . Y−1, and Y and then to respective loudspeakers 1, 2, . . . Y−1, and Y in the 1^{st} landscape configuration of Electronic Device 500. Router algorithm 3 directs a third combination of input audio signals 1, 2, . . . X−1, and X to respective amplifiers 1, 2, . . . Y−1, and Y and then to respective loudspeakers 1, 2, . . . Y−1, and Y in the 2^{nd} landscape configuration of Electronic Device 500. Router algorithm 4 directs a fourth combination of input audio signals 1, 2, . . . X−1, and X to respective amplifiers 1, 2, . . . Y−1, and Y and then to respective loudspeakers 1, 2, . . . Y−1, and Y in the 2nd portrait configuration of Electronic Device 500. The purpose of routing or directing different input audio signals to different loudspeakers in the different spatial orientations of Electronic Device 500 is to provide stereo, center channel or other sound effects in relation to video inputs or games in each such spatial orientation of Electronic Device 500.

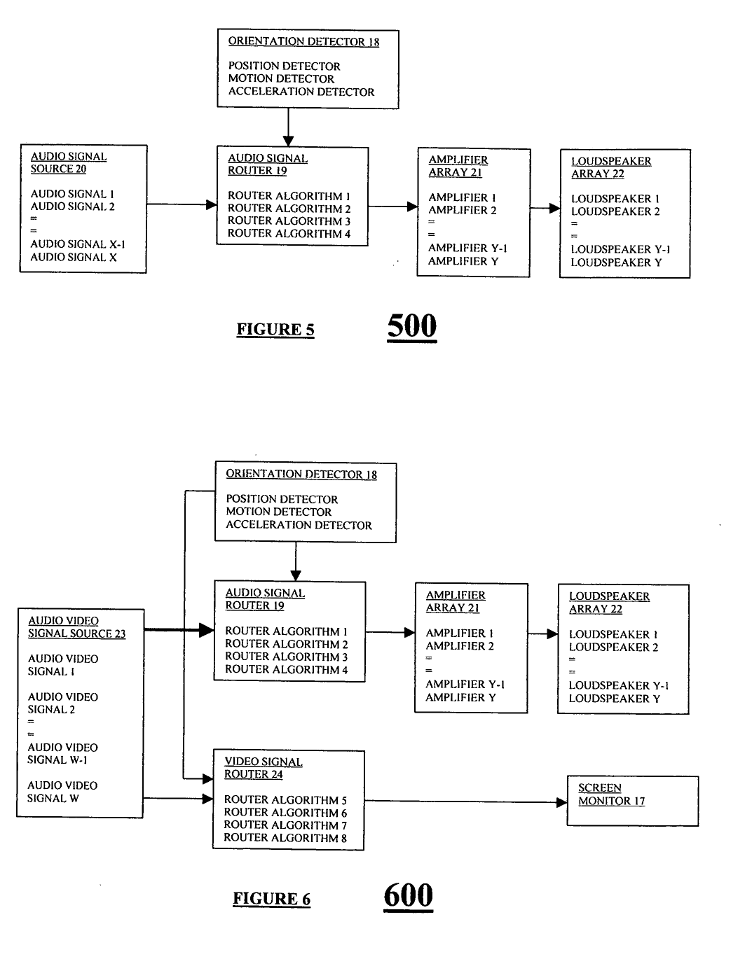

### FIG. 6

FIG. 6 shows the components which route input video signals and input audio signals in the various configurations of Electronic Device 600 according to the present invention.

FIG. 6 shows input audio-video signal source 23; audio signal router 19; amplifier array 21; loudspeaker array 22; video signal router 24, screen-monitor 17, and orientation sensor 18. Input audio-video signal source 23 provides combined audio-video signals 1, 2, . . . W−1, and W which may be pre-stored in Electronic Device 500 such as an I Tune database or other internal source. In the alternative, input audio-video signal source 23 provides combined audio-video signals 1, 2, . . . W−1, and W which may be received by Electronic Device 500 from an internet source or other external source. Audio signal router 19 may receive or may have stored therein fixed or variable router algorithms 1, 2, 3, and 4. Video signal router 24 may receive or may have stored therein fixed or variable router algorithms 5, 6, 7, and 8. Amplifier array 21 comprises amplifiers 1, 2, . . . Y−1, and Y. Loudspeaker array 22 comprises loudspeakers 1, 2, . . . Y−1, and Y. Orientation sensor 18 detects or determines the spatial or physical orientation of Electronic Device 500. Orientation sensor 18 may be a position sensor or detector, a motion sensor or detector, or an acceleration sensor or detector according to the cited prior art references of Abe, Robin and Zhao.

Audio signal router algorithm 1 directs a first combination of input audio signals 1, 2, . . . W−1, and W to respective amplifiers 1, 2, . . . Y−1, and Y and then to respective loudspeakers 1, 2, . . . Y−1, and Y in the 1^{st} portrait configuration of Electronic Device 600. Audio signal router algorithm 2 directs a second combination of input audio signals 1, 2, . . . W−1, and W to respective amplifiers 1, 2, . . . Y−1, and Y and then to respective loudspeakers 1, 2, . . . Y−1, and Y in the 1^{st} landscape configuration of Electronic Device 600. Audio signal router algorithm 3 directs a third combination of input audio signals 1, 2, . . . W−1, and W to respective amplifiers 1, 2, . . . Y−1, and Y and then to respective loudspeakers 1, 2, . . . Y−1, and Y in the 2^{nd} landscape configuration of Electronic Device 600. Audio signal router algorithm 4 directs a fourth combination of input audio signals 1, 2, . . . W−1, and W to respective amplifiers 1, 2, . . . Y−1, and Y and then to respective loudspeakers 1, 2, . . . Y−1, and Y in the 2nd portrait configuration of Electronic Device 600.

Video signal router algorithm 5 directs the corresponding or respective input video signal 1, 2, . . . W−1 or W to screen-monitor 17 in the 1^{st} portrait configuration of Electronic Device 600. Video signal router algorithm 6 directs the corresponding or respective input video signal 1, 2, . . . W−1 or W to screen-monitor 17 in the 1^{st} landscape configuration of Electronic Device 600. Video signal router algorithm 7 directs the corresponding or respective input video signal 1, 2, . . . W−1 or W to screen-monitor 17 in the 2^{nd} landscape 1^{st} configuration of Electronic Device 600. Video signal router algorithm 8 directs the corresponding or respective input video signal 1, 2, . . . W−1 or W to screen-monitor 17 in the 2^{nd} portrait configuration of Electronic Device 600. “Corresponding or respective” means the video signal component being routed by video signal router 24 of the combined audio-video signal whose audio signal component is simultaneously being routed by audio signal router 19.

While the present invention has been described in terms of specific illustrative embodiments, it will be apparent to those skilled in the art that many other embodiments and modifications are possible within the spirit and scope of the disclosed principle.

What is claimed is:

1. A sound producing system comprising:
A sound producing transducer array further comprising a plurality of sound producing transducers;
A plurality of input audio signals;
Wherein a first input audio signal is applied to a first sound producing transducer when said sound producing transducer array is in a first spatial orientation; and
Wherein a second input audio signal is applied to said first sound producing transducer when said sound producing transducer array is in a second spatial orientation.

2. A sound producing system comprising:
A sound producing transducer array further comprising a plurality of sound producing transducers;
A plurality of input sound signals;
Wherein said plurality of input sound signals are applied in a first combination to said plurality of sound producing transducers when said sound producing transducer array is in a first spatial orientation; and
Wherein said plurality of input sound signals are applied in a second combination to said plurality of sound producing transducers when said sound producing transducer array is in a second spatial orientation.

3. In the system of claim 2: said second spatial orientation being 90 degrees from said first spatial orientation.

4. In the system of claim 2: said second spatial orientation being 180 degrees from said first spatial orientation.

5. In the system of claim 2: said system also comprising position sensing means for detecting when said sound producing transducer array is in its first spatial orientation or in its second spatial orientation; and said plurality of input sound signals being applied to said plurality of sound producing transducers in said first combination or in said second combination in response to said position sensing means.

6. In the system of claim 2: said system also comprising motion sensing means for detecting when said sound producing transducer array changes from said first spatial orientation to said second spatial orientation and vice versa; and said plurality of input sound signals being applied to said plurality of sound producing transducers in said first combination or in said second combination in response to said motion sensing means.

7. In the system of claim 2: said system also comprising acceleration sensing means for detecting when said sound producing transducer array changes from said first spatial orientation to said second spatial orientation and vice versa; and said plurality of input sound signals being applied to said plurality of sound producing transducers in said first combination or in said second combination in response to said acceleration sensing means.

8. In the system of claim 2: said sound producing transducer array being substantially located on a common plane.

9. In the system of claim 2: said sound producing transducer array being substantially located on a common plane; said common plane having a perpendicular axis; and said second spatial orientation being reached upon the rotation of said sound producing transducer array about said perpendicular axis.

10. An electronic device comprising:
A housing; said housing further comprising a first surface;
A sound producing transducer array further comprising a plurality of sound producing transducers; said sound producing transducer array being located on said first surface of said housing;
Wherein a first set of input audio signals are applied to said plurality of sound producing transducers when said electronic device is in a first spatial orientation; and
Wherein a second set of input audio signals are applied to said plurality of sound producing transducers when said electronic device is in a second spatial orientation.

11. In the system of claim 10: said first surface having a perpendicular axis; and said second spatial orientation being rotated 90 degrees from said first spatial orientation about said perpendicular axis.

12. In the system of claim 10, said first surface having a perpendicular axis; and said second spatial orientation being rotated 180 degrees from said first spatial orientation about said perpendicular axis.

13. In the system of claim 10: said electronic device also comprising position sensing means for detecting when said electronic device is in said first spatial orientation or in said second spatial orientation; and said first set of input audio signals being applied to said plurality of sound producing transducers or said second set of input audio signals being applied to said plurality of sound producing transducers in response to said position sensing means.

14. In the system of claim 10: said electronic device also comprising motion sensing means for detecting when said electronic device changes from said first spatial orientation to said second spatial orientation and vice versa; and said first set of input audio signals being applied to said plurality of sound producing transducers or said second set of input audio signals being applied to said plurality of sound producing transducers in response to said motion sensing means.

15. In the system of claim 10: said system also comprising acceleration sensing means for detecting when said sound producing transducer array changes from said first spatial orientation to said second spatial orientation and vice versa; and said first set of input audio signals being applied to said plurality of sound producing transducers or said second set of input audio signals being applied to said plurality of sound producing transducers in response to said acceleration sensing means.

16. An electronic device comprising:
A housing; said housing further comprising a first surface and a second surface;
A sound producing transducer array further comprising a plurality of sound producing transducers; said plurality of sound producing transducers being distributed on said first surface and on said second surface of said housing;
Wherein a first set of input audio signals are applied to said plurality of sound producing transducers when said electronic device is in a first spatial orientation; and
Wherein a second set of input audio signals are applied to said plurality of sound producing transducers when said electronic device is in a second spatial orientation.

17. In the system of claim 16: said housing further comprising a third surface with a perpendicular axis; and said second spatial orientation being rotated 90 degrees from said first spatial orientation about said perpendicular axis.

18. In the system of claim 16: said housing further comprising a third surface with a perpendicular axis; and said second spatial orientation being rotated 180 degrees from said first spatial orientation about said perpendicular axis.

19. In the system of claim 16: said electronic device also comprising position sensing means for detecting when said electronic device is in said first spatial orientation or in said second spatial orientation; and said first set of input audio signals being applied to said plurality of sound producing transducers or said second set of input audio signals being applied to said plurality of sound producing transducers in response to said position sensing means.

20. In the system of claim 16: said electronic device also comprising motion sensing means for detecting when said electronic device changes from said first spatial orientation to said second spatial orientation and vice versa; and said first set of input audio signals being applied to said plurality of sound producing transducers or said second set of input audio signals being applied to said plurality of sound producing transducers in response to said motion sensing means.

21. In the system of claim 16: said electronic device also comprising acceleration sensing means for detecting when said sound producing transducer array changes from said first spatial orientation to said second spatial orientation and vice versa; and said first set of input audio signals being applied to said plurality of sound producing transducers or said second set of input audio signals being applied to said plurality of sound producing transducers in response to said acceleration sensing means.

22. In the system of claim 16: wherein said second spatial orientation is rotated at least 45 degrees counter-clockwise relative to said first spatial orientation about said perpendicular axis.

23. In the system of claim 16: wherein said second spatial orientation is rotated at least 45 degrees clockwise relative to said first spatial orientation about said perpendicular axis.

24. In the system of claim 16: wherein said second spatial orientation is rotated at least 135 degrees counter-clockwise relative to said first spatial orientation about said perpendicular axis.

25. In the system of claim 16: wherein said second spatial orientation is rotated at least 135 degrees clockwise relative to said first spatial orientation about said perpendicular axis.

26. In the system of claim 17:
said system also comprising a screen monitor; said screen being located on said third surface;
said screen being viewable in the portrait mode when said electronic device is in its first spatial orientation; and
said screen being viewable in the landscape mode when said electronic device is in its second spatial orientation.
